(19) United States
(12) Patent Application Publication
(10) Pub. No.: US 2013/0295515 A1
(43) Pub. Date: Nov. 7, 2013

(54) DEVICE AND METHOD FOR STABILIZATION OF TEETH

(71) Applicants: David R Musich, Inverness, IL (US); Paul Gange, Itasca, IL (US)

(72) Inventors: David R Musich, Inverness, IL (US); Paul Gange, Itasca, IL (US)

(21) Appl. No.: 13/874,578

(22) Filed: May 1, 2013

Related U.S. Application Data
(60) Provisional application No. 61/641,873, filed on May 2, 2012.

(51) Int. Cl. A61C 7/00

(52) U.S. Cl. CPC A61C 7/00
USPC 433/18; 433/24

(57) ABSTRACT

An orthodontic arch stabilization device comprises a plurality of “s” shaped links connected, in double rows; to form an elongated chain is provided. The device is secured through selected links directly to a patient's teeth which are to be stabilized. The links can be rigid and of metal, such as stainless steel or a noble metal. A method of stabilizing teeth employs the arch stabilization device includes preparing the lingual surfaces of the teeth to be stabilized, applying adhesive to the lingual surfaces of the teeth, placing the device in direct contact with the adhesive on the lingual surfaces to affix the device in close proximity to the teeth within the mouth.

### CROSS-REFERENCES TO RELATED APPLICATIONS

The present application is a continuation of provisional Application No. 61/641,873; filed on May 2, 2012, the full disclosures of which is incorporated herein by reference.

### FIELD OF THE INVENTION

The present invention concerns the stabilization of teeth particularly after the correction of malocclusion of or injury to teeth. More particularly the present invention concerns a device and method to stabilize and strengthen an individual tooth or groups of teeth during and after injury, illness and/or correction of malocclusion. Stabilization after malocclusions due to secondary to severe conditions, such as cleft lip and palate and Down Syndrome are also addressed by the application of the present invention.

### BACKGROUND OF THE INVENTION

Tooth stabilization and strengthening techniques used during and after illness and injury and as retention technique after orthodontia are known in the art; including as described in our U.S. Pat. No. 5,964,589. U.S. Pat. No. 5,964,589 is incorporated herein by reference as if set forth in full here. Bonded retainers comprising one or more wires and or spiral wires bonded to teeth (via pads or brackets acting as an intermediary between the teeth and wire) have been used for years to maintain tooth position. Dental arch stabilization following corrective orthodontic tooth movement, healing from traumatic tooth displacement, and stabilization of mobile teeth affected by periodontal disease currently employ one or more bonded wires, which may be a single strand of large gauge wire, a multi-strand wire, or strands of fiberglass cemented (bonded) directly or secured to stainless steel bases that are affixed to selected teeth of a patient in lieu of removable retainers. These wires and bases have often been created from noble materials, such as gold or platinum or other expensive alloys which, due to fluctuations in metals markets have become exceedingly costly and almost prohibitive to use.

An example of the use of multi-strand arch wires is described in U.S. Pat. No. 5,344,315; in U.S. Pat. Nos. 3,618,214 and 3,997,970 wherein a coiled spring is described. However, coiled springs are most commonly used for purposes of control of tooth movement rather than tooth stabilization. As these devices are indirectly bonded to the teeth (via pads and bases), and are reviewed and monitored periodically by a dental professional, their use is considered safe and effective. If damage occurs to the devices, it has been found that injury can occur, either immediately or over time, as unintended forces can be placed on teeth causing harm, tooth movement and other serious damage; see for example: Severe complication of a bonded mandibular lingual retainer, Pazera, Fudalej and Katsaros, American Journal of Orthodontics and Dentofacial Orthopedics, September 2012, Vol. 142, Issue 3, pp 406-409.

The existing twisted wires used for tooth stabilization are bulky to the tongue and can be activated and cause serious destabilization to the attached teeth resulting in the need for orthodontic retreatment with braces defeating the purpose of the older devices known in the prior art. Prior art devices that use a 14 k gold chain, that has been in use for about 12 years, however, in certain clinical situations have been shown to weaken and break, requiring mild corrections in tooth position, repair and added expense and discomfort to the patient.

The method of securing many of the above mentioned devices, which comprise slim wires, coils or chains, in the mouth has included employing brackets and/or pads to hold the devices to the teeth. The wires, coils and chains being so small or having limited surface area that they cannot be directly attached to teeth. These brackets are typically created specifically for use on specific teeth and, therefore, they must be measured to fit. Measurements, or often molds, must be made so as to provide the custom fit needed by the prior art. As such, it is often the case that measurement and fit must be done after the removal of a first device, such as braces or other malocclusion correction devices. The measurements or molds must then be sent to a laboratory for the creation of the brackets or pads, thereby leaving the teeth unaided for the time that such brackets or pads require for creation and transportation. Such delay can cause unwanted movement in teeth damaging to the corrective procedures previously endured.

In our US patent, noted above and which has been incorporated above by reference, we established the use of a chain device instead of single or multi-strand wires or coiled springs. The chain, like the prior art before it, is meant to be attached to the tooth on the surface thereof via a prior applied pad onto which the chain is affixed. While the chain is a substantial improvement over the prior existing art, the use of pads onto which to affix the chain to the teeth has proved problematic. Among the issues created are the above mentioned delays in pad creation and in that the chain, held by the pad, is a fortiori distant from the tooth surface and is therefore subject to being harmed by food, or other objects in the mouth as well as powerful forces native to the mouth. Damage to the chain, as a result of chewing or other actions, can have dramatic effects on the attached teeth, as described above. Further, chains can also stretch or become distorted over time causing the application of unintended forces on teeth, called activations.

While the noted improvements and other attempted improvements in arch stabilization devices have advanced the art, each have disadvantages. The primary objection to these devices is the propensity, after initial installation and adjustment, to their being deformed or broken by normal mastication, particularly of hard objects, such as bones, nuts, crusts, ice and other objects, or upon being accidentally struck, such as in a fall or by a blow to the mouth of the patient and causing damage as a result thereof. There is also a tendency for wires, coils and chains, particularly those made of gold or other soft metals, to be affected by the heat within the mouth and caused by hot foods and drink placed in the mouth. Persons having ordinary skill in the art will be aware that large temperature changes in the mouth caused by hot drinks or food and then very cold items like ice, iced drinks or ice cream can have deleterious effects on metal within the mouth as well as the natural structures within the mouth.

Unintended and undesirable deformation or breaking of the arch stabilization device causes discomfort to the patient and requires adjustment or replacement of the device in order for proper stabilization to continue and damage to be stemmed. Deformation is also the cause of incorrect adjustment, as kinks or bends in the device can cause unintended forces to be placed on teeth. It will be understood that when teeth are attached or otherwise combined together by any device having structural potency, such as a chain, coil or wire, forces exerted on one tooth will be transferred to the others so joined. Teeth that are already tenuously held and are subjected to forces can be damaged and or cause damage within the mouth.

Therefore, there is a need for dental arch stabilization devices, which have improved resistance to more than momentary deformation, while maintaining the corrected tooth positions. There is also a need to provide a tooth stabilization device and method that is strong, durable, safe and easy to install, adjust and remove when needed and is inexpensive to manufacture. There is also a need to provide an arch stabilization device that can be held away from dangerous conditions within the mouth.

Objects and advantages of the present invention will become apparent as the description proceeds.

### SUMMARY OF THE INVENTION

In accordance with the present invention, an orthodontic arch stabilization device adapted to be secured to selected teeth of a patient to be treated is provided. The device comprises a plurality of “s” shaped links connected to form an elongated chain and adapted to have selected links thereof secured directly to selected teeth of the patient. In the creation of the chain, the links are rigid and are formed of metal. In a preferred embodiment, links are formed of stainless steel. It will be understood that the metal used in the creation of the links can be selected from the noble metals and their alloys, including a gold alloy, platinum or an alloy of at least two metals such as an alloy of nickel and titanium. The preferred range of sizes of the device are a thickness of the device between 0.25 mm and 0.35 mm and a height (measured in the longitudinal direction of a tooth) of between 0.85 mm and 1.5 mm.

The present invention also provides a method of stabilizing teeth of a patient by using the device of the present invention in a novel manner In the method, the lingual surfaces of the teeth to be stabilized are prepared to accept an adhesive, in a manner known to persons having ordinary skill in the art. The arch stabilization device, comprising a plurality of “s” shaped links connected to form an elongated chain, is adapted to have selected links secured directly to the prepared lingual surfaces of the teeth to be stabilized. The arch stabilization device is provided of a length measured to provide direct contact with the lingual surfaces of the teeth to be stabilized and a dental adhesive, of a type known to persons having ordinary skill in the art, is applied to the lingual surfaces of the teeth to be stabilized while placing the arch stabilization device onto the adhesive such that links of the device are in direct contact with the lingual surface of each tooth to be stabilized.

The object of one embodiment of this tooth stabilization mechanism with method for same is to provide dental arch stabilization through a mechanism that can be placed either totally passive or partially active (through work hardening). In addition the design eliminates the possibility of other “twist or cable wire designs” that can be inadvertently activated by hard foods, trauma and dental cleaning instruments.

In the totally passive range of utility the invention would be a “formless chain” of tight serpentine links whose form would be generated by the teeth to which it is attached.

In the “partially active” range the tight serpentine linkage would be work hardened through link compression generated by an arch forming pliers. The compression would have the effect of squeezing the links into each other, thus stiffening the stainless steel chain to the desired form of the teeth to be stabilized.

The preferred use of 18-8 surgical grade stainless steel with serpentine linkage provides added strength that the more open link and softer alloy chain described in the prior art.

In one form, the invention is a tooth stabilization mechanism with method and design that can handle both temperature changes and unpredictable forces on the teeth. In addition the device is thin enough so that it does not interfere with normal function of the dentition and the soft tissues of the mouth, especially the tongue. Prior art mechanisms do not accomplish these objectives on a reliable basis and in a broad range of patient situations.

A more detailed explanation of the invention is provided in the following description and claims and is illustrated in the accompanying drawings.

### BRIEF DESCRIPTION OF THE DRAWINGS

FIG. 1 is a perspective view of a device of the prior art.

FIG. 2 is a perspective view of a segment of the device of the present invention.

FIG. 3 is a plan view, taken from the top of a segment of the device of the present invention.

FIG. 4 is a cross-sectional view of the device of the present invention taken from line 4-4 of FIG. 3.

FIG. 5 is a perspective occlusal view of the device of the present invention in use.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

Referring to FIG. 1 a chain of the type disclosed in our prior art US patent is shown. As noted in the '589 patent, the chain 10 is made of a plurality of metal links 12 that are connected in chain-like fashion to form a chain of links 12. The links 12, and hence the device 10, are adapted to be secured to pads, which are attached on selected teeth of a patient to be treated, the device 10 being attached to the pads. Links 12 are preferably rigid, while device 10 is relatively flexible due to its chain-like structure. In the operation of the prior art, various links of the chain are attached to pads that are attached to tooth surfaces in a manner useful to the stabilization of the teeth.

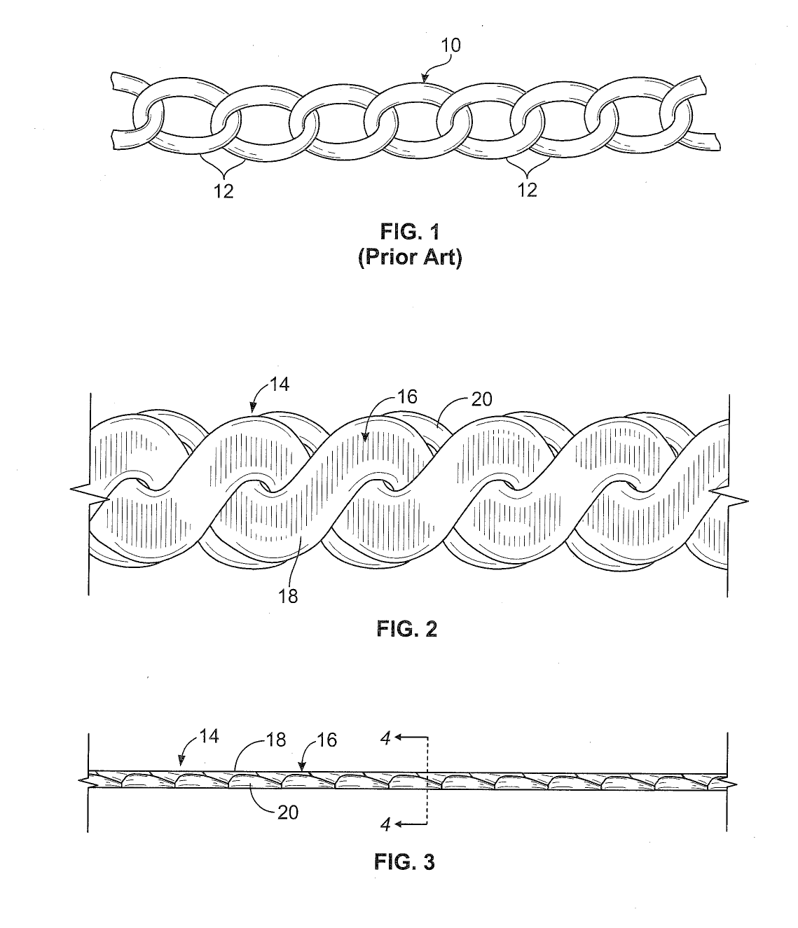

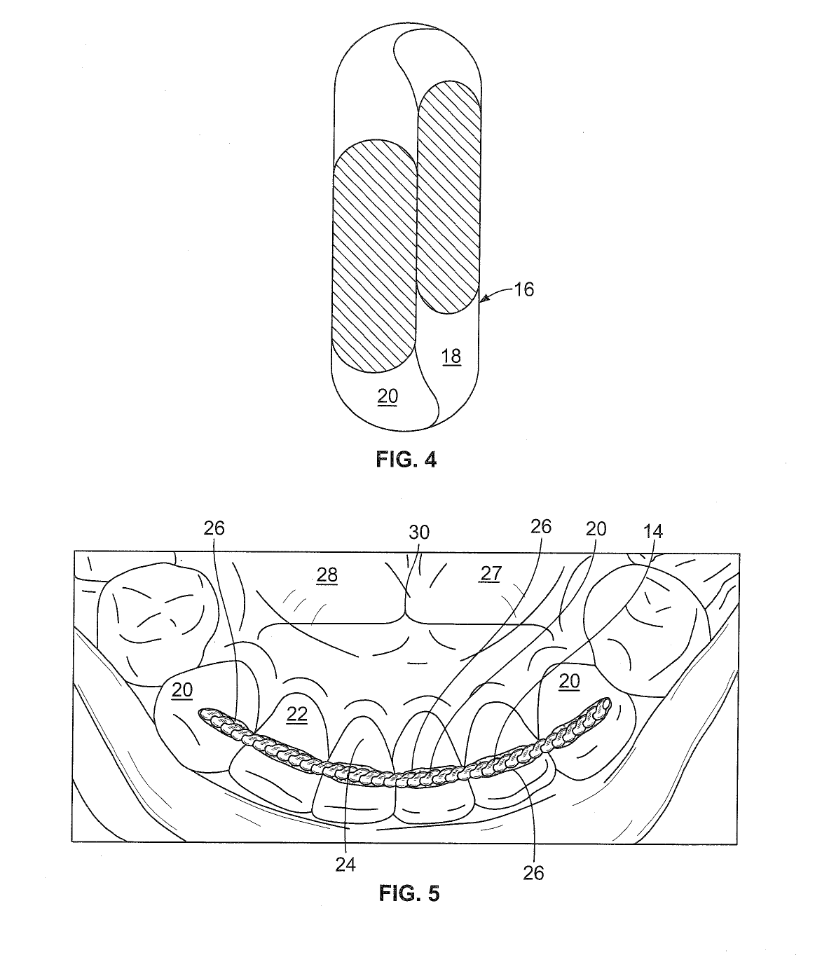

Referring now to FIG. 2, a serpentine link design device 14 is shown. It will be seen that the device is created by the interlocking of “s” shaped links 16 in at least two layers (as shown in FIGS. 3 and 4), an inner layer 18 and outer layer 20. The device of the present invention is preferably composed of hammered “s” shaped links 16 that are laid next to each other with another identical set of links 16 laid in parallel below the first (adjacent the first side, as best seen in FIG. 3) and connected together in a manner known to persons having skill in the art. FIG. 3 shows the two layers of “s” shaped links 16 side by side and FIG. 4 shows a cross-sectional view, taken along line 4-4 of FIG. 3, of the two layers 18, 20, affixed to form device 14. It will be understood that the dimensions of the device has are preferably within the range of 0.25-0.35 mm thickness and 0.85-1.5 mm in height, with a preferred embodiment having a thickness of between 0.29 to 0.33 mm. The length of the device of the present invention, of course, is determined by the distance over which the teeth to be attached extend. It will be understood that variations of thickness and height can be used without departing from the novel scope of the present invention, but that the range of thickness and height has been found to be optimal to provide the strength needed for stabilization while diminishing the deleterious effects described above incumbent on prior art arch support devices.

Further, in a preferred embodiment the device 14 is created from stainless steel, preferably 18-8 surgical grade stainless steel as is known to persons having skill in the art. The device 14 can also be made of gold, platinum and other metals and alloys typically used in dental or surgical procedures, without departing from the novel scope of the present invention.

As shown in FIG. 2 the linkage 16 has the benefits of increased undercuts to add to the strength of its adhesion via the bonding adhesive 26. This is further increased by the tightness of the individual “s” shaped links 16 within the linkage and the flatness of the profile (as shown in FIGS. 2 through 4). The flatness of the links 16 aids in attachment of the links directly to the tooth surface, thereby bringing the device 14 close to the tooth 22 for better protection of the device and less chance of damage to the device, while allowing for long-term (3 to 20 years) intraoral cementation without irritating the tongue 27. The combination of the tighter links and the stainless steel add to its overall effectives as an orthodontic stabilization device—both in strength and long-term usage intraorally. In addition the stainless steel device 14 will not corrode in the fluids in the mouth and is significantly less expensive than gold or other precious metals often used in dentistry. Further, stainless steel is more resistant to extreme changes in temperature allowing for better survival during phases of hot and cold ingestion of foods and drink in the mouth. It will be understood by persons having ordinary skill in the art that this is a clear departure from previously described link designs in the prior art.

The use of “s” shaped links 16 further creates a device 14 that remains flexible such that it can be bent and formed for placement on the teeth 22. The bendability of the device further allows for easy adjustment of the lingual anatomy of the incisors prior to placement at chairside. Because the device 14 can be placed directly onto the tooth surface 24, with flowable adhesive 26, in addition to its flexibility and strength, placement is completed more quickly and accurately than prior devices, with less discomfort to the patient and can be done immediately after the removal of other dental appliances, such as braces.

Referring now to FIG. 5, an occlusal view of a mouth 28 is shown. Teeth 20, for which support is desired, are shown being attached together with a device 14 of the present invention. It can be seen that device 14 is attached directly, via adhesives 26, to the lingual surface 24 of at least six teeth 20. In this position, the device 14 is passive so that mastication of harder foods will not create a bend and create an activation resulting in movement of the teeth 20 connected in the stabilized section 30. Details of adaptation can be placed into the device to lay in close contact to the individualized tooth anatomy which enhances its capacity for stabilization of the dentition to which it is attached.

The present invention can be fabricated directly to the lingual surface 24 of the teeth 20, chairside, which eliminates lab costs and treatment delays. This allows the device to be bonded immediately before or immediately after brace removal, thereby also avoiding delays in supporting teeth that can allow unwanted movements.

Advancement in adhesives, as known to persons having ordinary skill in the art, allows additional reliability when bonded with flowable adhesive 26 which further resists breakage of the bonded attachment at the tooth surface 24. It will be understood that this added strength allows added intraoral uses: stabilization of periodontal disease weakened teeth with extra-coronal splinting; and teeth that suffer trauma and require stabilization during initial healing phase.

The device 14 of the present invention thus installed, will maintain the desired longitudinal tension or forces on the arch between the teeth to which the device is secured, while resisting deformation, or more than momentary deformation followed by return to device to its prior position after an angled or transverse force to the device has been encountered. In the preferred embodiment, the invention is a tooth stabilization mechanism with method and design that can handle both temperature changes and unpredictable forces on the teeth. In addition the device is thin enough so that it does not interfere with normal function of the dentition and the soft tissues of the mouth, especially the tongue.

Although an illustrative embodiment of the invention has been shown and described, it is to be understood that various modifications and substitutions may be made by those skilled in the art without departing from the novel spirit and scope of the invention.

What is claimed is:

1. An orthodontic arch stabilization device adapted to be secured to selected teeth of a patient to be treated, comprising a plurality of “s” shaped links connected to form an elongated chain and adapted to have selected links thereof secured directly to selected teeth of the patient.

2. The orthodontic arch stabilization device of claim 1, wherein the links are rigid.

3. The orthodontic arch stabilization device of claim 1, wherein the links are formed of metal.

4. The orthodontic arch stabilization device of claim 3, wherein the links are formed of stainless steel.

5. The orthodontic arch stabilization device of claim 3, wherein the metal is selected from the noble metals and their alloys.

6. The orthodontic arch stabilization device of claim 5, wherein the metal is a gold alloy.

7. The orthodontic arch stabilization device of claim 5, wherein the metal is platinum.

8. The orthodontic arch stabilization device of claim 3, wherein the links are formed of an alloy of at least two metals.

9. The orthodontic arch stabilization device of claim 8, wherein the metal is an alloy of nickel and titanium.

10. The orthodontic arch stabilization device of claim 1, wherein the links have a thickness in the range of 0.25 mm to 0.35 mm.

11. The orthodontic arch stabilization device of claim 1, wherein the links have a thickness in the range of 0.29 mm to 0.33 mm.

12. The orthodontic arch stabilization device of claim 1, wherein the device has a height in the range of 0.85 mm to 1.5 mm.

13. A method of stabilizing teeth of a patient comprising:
(a) preparing lingual surfaces of teeth to be stabilized to accept an adhesive;
(b) providing an arch stabilization device comprising a plurality of “s” shaped links connected to form an elongated chain and adapted to have selected links thereof secured to the lingual surfaces of the teeth to be stabilized, the arch stabilization device having a length measured to provide direct contact with the lingual surfaces of the teeth to be stabilized;
(c) applying a dental adhesive to the lingual surfaces of the teeth to be stabilized;
(d) placing the arch stabilization device to the adhesive applied to the lingual surfaces of the teeth to be stabilized so that links of the device are in direct contact with the lingual surface of each tooth to be stabilized.
